(19) United States
(12) Patent Application Publication
(10) Pub. No.: US 2008/0204774 A1
(43) Pub. Date: Aug. 28, 2008

(54) Print controlling program, print controlling apparatus, image forming apparatus and print controlling method

(75) Inventor: Noriyuki Matsushima, Edogawa-ku (JP)

Correspondence Address: SIDLEY AUSTIN LLP, 717 NORTH HARWOOD, SUITE 3400, DALLAS, TX, 75201, US

(73) Assignee: KONICA MINOLTA BUSINESS TECHNOLOGIES, INC.

(21) Appl. No.: 12/009,044

(22) Filed: Jan. 16, 2008

(30) Foreign Application Priority Data
Feb. 26, 2007 (JP) 2007-045991

(51) Int. Cl. H04N 1/60

(52) U.S. Cl. 358/1.9

(57) ABSTRACT

There is described a print controlling apparatus that acquires print data, which are described in the PDL and include objects having image attributes being different from each other, and converts the print data to raster data. When converting the print data to the raster data, the apparatus creates attribute data, in which an image processing attribute indicating a kind of image processing to be applied to each of pixels represented by the raster data is recorded, for every pixel included in the pixels, and then, applies an image processing based on the attribute data to the raster data. The attribute data designates one of image processing attributes that include a plurality of image processing attributes determined according to kinds of the image attributes of the objects and a specific image processing attribute determined corresponding to another image attribute being different from every one of the image attributes of the objects.

This application is based on Japanese Patent Application No. 2007-045991 filed on Feb. 26, 2007, with Japan Paten Office, the entire content of which is hereby incorporated by reference.

### BACKGROUND OF THE INVENTION

1. Field of the Invention

The present invention relates to a print controlling program, a print controlling apparatus, an image forming apparatus and a print controlling method, and specifically relates to a print controlling program, a print controlling apparatus, an image forming apparatus and a print controlling method, each of which creates attribute data in which attribute information in regard to data described in raster format is recorded.

2. Description of Related Art

In recent years, there have been increasingly proliferated in the market various kinds of copiers or multi-functional apparatuses, each provided with a combination of plural functions, such as a copy function, a facsimile function, a printer function, a scanner function, etc., (hereinafter, referred to as an image forming apparatus as a general term for each of them). When the image forming apparatus is employed as the network printer to implement the printing operation, at first, a document is created by using the application program installed in advance in the computer terminal device coupled to the network, and then, the created document is converted to the print data in the format of the Page Description Language (hereinafter, also referred to as the PDL, for simplicity) by employing software (printer driver) for controlling the image forming apparatus. Successively, the print data created by the computer terminal device is transmitted to the RIP (Raster Image Processor) controller. Receiving the print data from the computer terminal device, the RIP controller creates the data described in raster format (hereinafter, referred to as the raster data) from the print data received, and then, applies a predetermined color conversion processing to the raster data created, referring to a color conversion table, and successively, the raster data processed by the color conversion processing is transmitted to the image forming apparatus. Receiving the processed raster data from the RIP controller, the image forming apparatus implements the image forming operation based on the processed raster data received.

In this connection, in order to achieve the printing operation with an appropriate coloring, it is necessary that the color conversion processing should be performed on the basis of an appropriate color conversion table. For this purpose, for instance, Tokkai 2005-223695 Japanese Non-Examined Patent Publication) sets forth a method for creating color information in the case that an object in a color plate (digital color plate) different from process colors exists. The method, set forth in Tokkai 2005-223695, includes the operational steps of: confirming whether or not a Color (n) corresponding to a Spot (n), serving as its color name, is a specific color; when confirming that the Color (n) is the specific color, converting the CMYK values in accordance with the LUT of the pertinent specific colors so as to combined them into the outputting area; when confirming that the Color (n) is a process color, storing those CMYK values into the CMYK color correction area, and then, after applying the color correction processing to the CMYK values stored in the CMYK color correction area, combining them with the CMYK values residing in the outputting area, so as to create the color information at the time when including the color plate different from process colors.

However, since the feature of the abovementioned method resides in such a procedure that the color conversion path is changed during the step of object before creating the final image, and then, the final image is acquired by combining the CMYK values after acquiring them by applying the corresponding color conversion processing to each of them, the color conversion processing can be changed only in the unit of the object concerned.

For instance, in such the case that a specific area, such as a company logo, a color bar code or the like, in which the printed output color should be precisely designated, and another area in which an optimum color image, being optimum in a balance of the relative coloring, should be acquired, coexist in a certain object, if the color conversion processing is applied to the concerned object in accordance with the specific area, it is impossible to make the color balance of the other area optimum, while, if the color conversion processing is applied to the concerned object in accordance with the other area, it is impossible to acquire the desired coloring accuracy in the specific area. Accordingly, even if the method set forth in Tokkai 2005-223695 is employed, it is impossible to implement both the color conversion processing suitable for the specific area in which the precise coloring accuracy is required, and the other color conversion processing suitable for the other area in which the optimum color image, being optimum in the balance of the relative coloring, should be acquired, at a time.

Further, as a technology being different from the technology set forth in the abovementioned patent document, there has existed a conventional method for creating attribute data in which image processing attribute, specifying a color conversion processing condition for every pixel of raster data, are recorded. Conventionally, however, merely the image processing attribute specified for every object (namely, specified corresponding to its image attribute) is recorded, as this kind of the attribute data. Such the problem as mentioned in the above would occur not only in the color conversion processing, but also in an arbitral processing to be applied to the raster data, as well.

### SUMMARY OF THE INVENTION

To overcome the abovementioned drawbacks in conventional image forming apparatus, it is one of objects of the present invention to provide a print controlling program, a print controlling apparatus, an image forming apparatus and print controlling method, which make it possible to apply a processing operation to data, described in a raster format, corresponding to an attribute other than the image attribute.

Accordingly, at least one of the objects of the present invention can be attained by the print controlling program, the print controlling apparatus described as follows.

(1) According to a computer readable medium reflecting an aspect of the present invention, the computer readable medium storing a computer executable program to be executed at a time when print data, which is described in a Page Description Language and include objects having image attributes being different from each other, are converted to raster data, the program comprises program code for causing a computer to perform the step of: creating attribute data, in which an image processing attribute, indicating a kind of image processing to be applied to each of pixels represented by the raster data, is recorded, for every pixel included in the pixels; wherein the attribute data designates one of image processing attributes that include a plurality of image processing attributes determined according to kinds of the image attributes of the objects and a specific image processing attribute determined corresponding to another image attribute being different from every one of the image attributes of the objects.
(2) According to another aspect of the present invention, in the computer readable medium recited in item 1, the specific image processing attribute specifies a condition for an image processing to be applied to a partial area represented by a part of the raster data.
(3) According to still another aspect of the present invention, in the computer readable medium recited in item 1, the image processing includes one or more processing operation(s) selected from a color conversion processing, a brightness conversion processing, a smoothing processing and an edge-enhancement processing.
(4) According to a print controlling apparatus reflecting still another aspect of the present invention, the print controlling apparatus that acquires print data, which is described in a Page Description Language and include objects having image attributes being different from each other, and converts the print data to raster data, comprises: a print data acquiring section to acquire the print data; and an image creating section to create attribute data, in which an image processing attribute indicating a kind of image processing to be applied to each of pixels represented by the raster data is recorded, for every pixel included in the pixels, when converting the print data acquired by the print data acquiring section to the raster data, and then, to apply an image processing based on the attribute data to the raster data; wherein the attribute data designates one of image processing attributes that include a plurality of image processing attributes determined according to kinds of the image attributes of the objects and a specific image processing attribute determined corresponding to another image attribute being different from every one of the image attributes of the objects.
(5) According to still another aspect of the present invention, in the print controlling apparatus recited in item 4, the specific image processing attribute specifies a condition for an image processing to be applied to a partial area represented by a part of the raster data.
(6) According to yet another aspect of the present invention, in the print controlling apparatus recited in item 4, the image processing includes one or more processing operation(s) selected from a color conversion processing, a brightness conversion processing, a smoothing processing and an edge-enhancement processing.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a schematic diagram of a configuration of the printing system embodied in the present invention;

FIG. 2 shows a block diagram indicating a configuration of a client terminal device embodied in the present invention;

FIG. 3 shows a block diagram of a RIP server embodied in the present invention;

FIG. 4 shows a block diagram indicating a configuration of an image forming apparatus embodied in the present invention;

FIG. 5 shows a schematic diagram indicating a processing flow of an overall printing system embodied in the present invention;

FIG. 6 shows an explanatory schematic diagram for explaining relationships between document data, raster data and TAG bits, embodied in the present invention;

FIG. 7 shows a flowchart indicating a flow of operations to be conducted in a client terminal device embodied in the present invention; and

FIG. 8 shows a flowchart indicating a flow of operations to be conducted in a RIP server embodied in the present invention.

### DETAILED DESCRIPTION OF THE PREFERRED EMBODIMENT

As aforementioned in the “BACKGROUND OF THE INVENTION” section, in order to achieve the printing operation with the appropriate coloring, it is necessary that the color conversion processing should be performed on the basis of the appropriate color conversion table. However, in the conventional method, since a color conversion table can be set only in the object-by-object basis, in such the case that an object includes both of an area, such as a company logo, a color QR code (Registered Trademark of Denso Wave Incorporated, Tokyo, Japan) or the like, which requires the precise coloring accuracy, and another area which requires the balance of the relative coloring, there has been a problem that it is impossible to implement the color conversion processing suitable for the both areas.

In this connection, in the field of the professional printing (for instance, in the printing operation in which the print products are handled as the final merchandise), such as a POD (Print On Demand), etc., in order to avoid a deformation of a character shape, etc., due to the change in the content of the processing system concerned, sometimes, the rasterlized data having been once stored in a storage is reused later on. This handling method corresponds to the “stored plate” for storing a master plate of the offset printing, as the operating method employed in the printing field. Since the information specifying the condition of the processing corresponding to each of the pixels (hereinafter, referred to as the attribute information) has been lost from the abovementioned raster data corresponding to the “stored plate” as it is, there has been employed such a method that stores the attribute data called a TAG bit, in which the attribute information of each of the pixels represented by the raster data is recorded, associated with the raster data.

Although, in the conventional practice, the TAG bit is employed for determining image attribute of an object, such as a character, an illustration, a graph, a photographic image, etc., when applying a predetermined processing to every object, in the exemplified embodiments, the abovementioned definition of the TAG bit is extended to such an extent that an image processing attribute specifying an image processing condition, corresponding to an attribute being different from the image attribute, is also recorded in the TAG bit. In other words, according to the exemplified embodiments, the TAG bit is utilized for not only the processing operation corresponding to the image attribute, but also such a processing operation that corresponds to the attribute being different from the image attribute, such as the processing for a specific area, etc.

For instance, by recording the image processing attribute, which designates a specific color conversion processing to the specific area, into the TAG bit, it becomes possible to apply a desired processing to an area for which a color reproduction processing being different from the normal color controlling operation is necessary, such as a company logo, a color QR code, etc., without giving an adversely influence. Specifically, it becomes possible to obtain a remarkable effect in the field of the special usage, such as a POD (Print On Demand), etc.

### EMBODIMENT

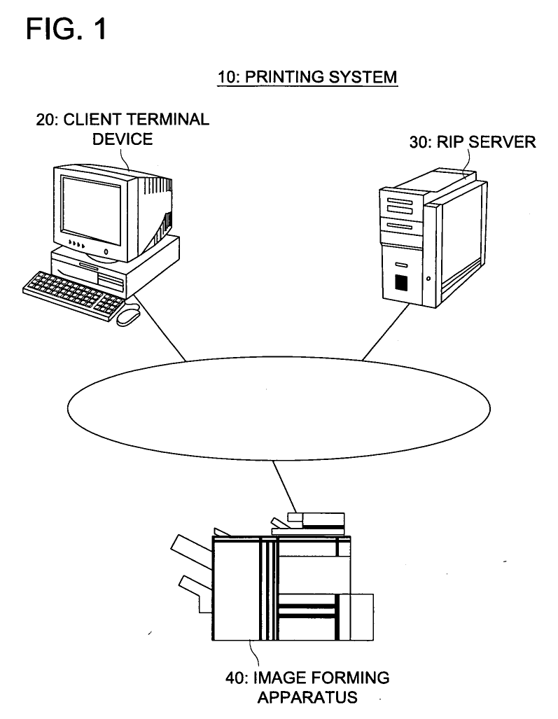

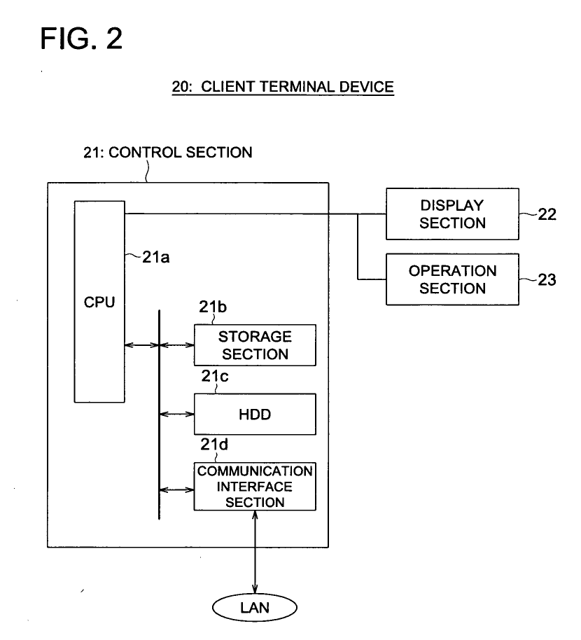

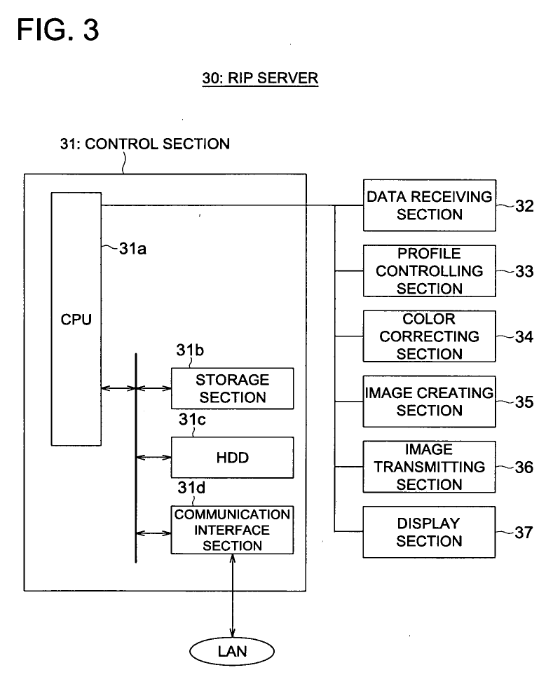

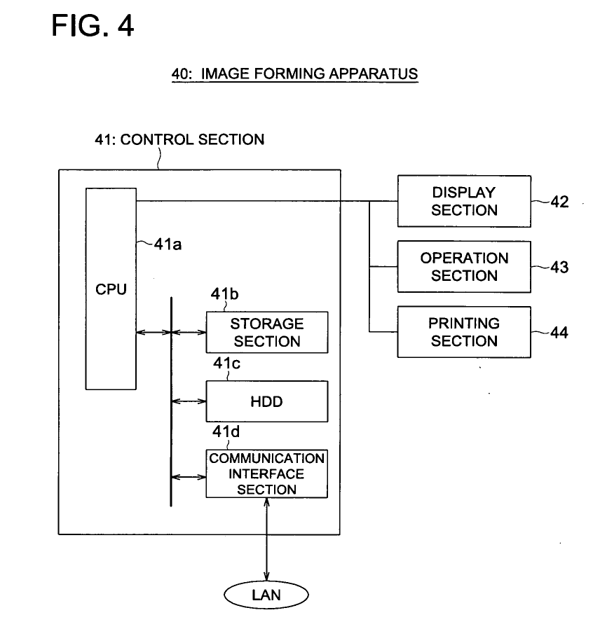

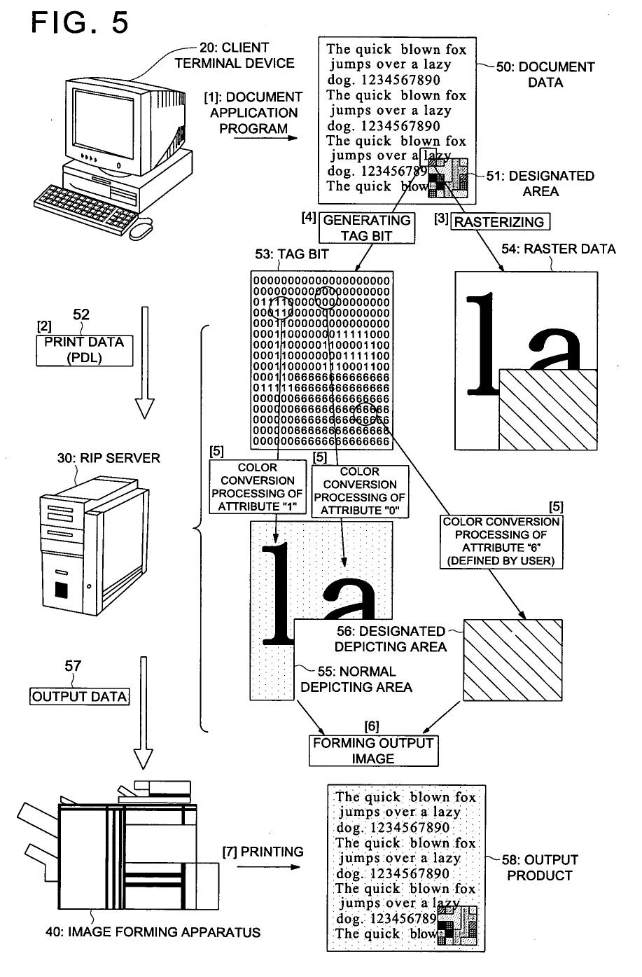

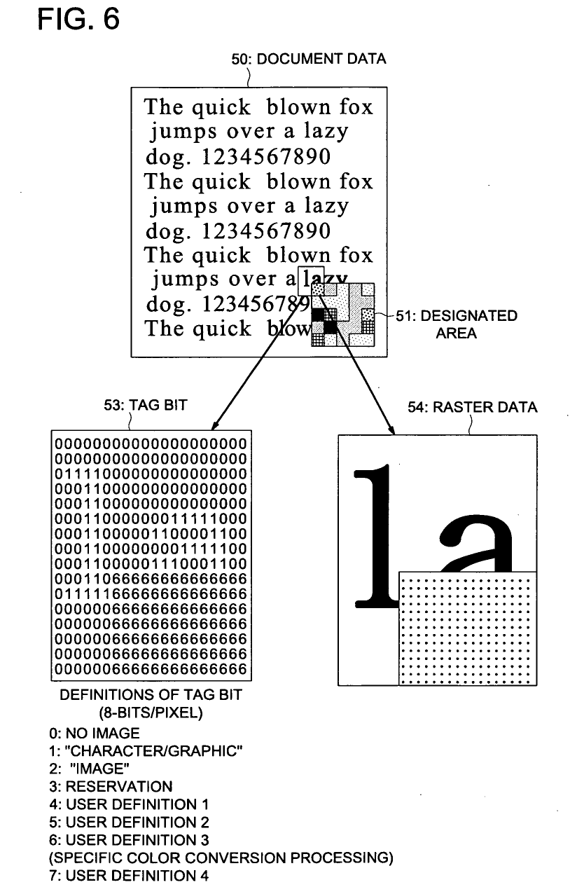

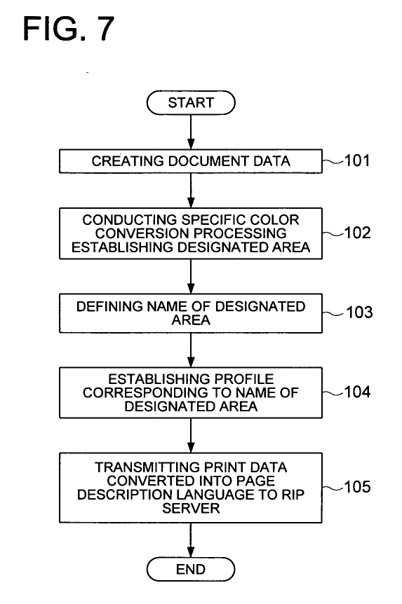

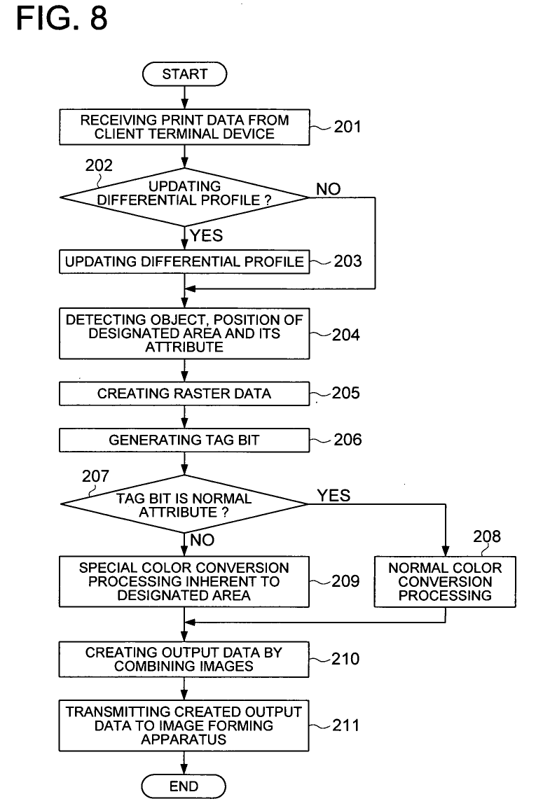

In order to describe the preferred embodiment of the present invention in detail, referring to FIG. 1 through FIG. 8, a controlling program, a controlling apparatus, an image forming apparatus and a print controlling method, embodied in the present invention, will be detailed in the following. FIG. 1 shows a schematic diagram of a configuration of the printing system embodied in the present invention, FIG. 2 shows a block diagram indicating a configuration of a client terminal device 20, FIG. 3 shows a block diagram of a RIP server 30, and FIG. 4 shows a block diagram indicating a configuration of the image forming apparatus. Further, FIG. 5 shows a schematic diagram indicating a processing flow of an overall printing system, while, FIG. 6 shows an explanatory schematic diagram for explaining relationships between document data, raster data and the TAG bits. Still further, FIG. 7 shows a flowchart indicating a flow of operations to be conducted in the client terminal device 20, while, FIG. 8 shows a flowchart indicating a flow of operations to be conducted in the RIP server 30.

As shown in FIG. 1, a printing system 10, embodied in the present invention, is constituted by: a single or a plurality of client terminal device(s) 20, each of which instruct the printing operation based on data (hereinafter, referred to as document data) created by an application program for creating the document (hereinafter, referred to as a document application program) or other data described in the Page Description Language converted from the document data (hereinafter, referred to as a print data); a single or a plurality of controlling apparatus(es) (hereinafter, referred to as a RIP server 30), such as a workstation, a personal computer, etc., each of which is provided with a RIP controller for converting the print data acquired from the client terminal device 20 to data being available in (or processable by) an image forming apparatus 40 (hereinafter, referred to as output data); and a single or a plurality of image forming apparatus(es) 40, such as a printer, a digital compound apparatus (or a multi-functioned apparatus), etc., each of which implements a printing operation based on the output data acquired. The single or the plurality of client terminal device(s) 20, the single or the plurality of RIP server(s) 30 and the single or the plurality of image forming apparatus(es) 40 are coupled to each other through a communication network, such as a LAN (Local Area Network), a WAN (Wide Area Network), etc.

Further, as shown in FIG. 2, the client terminal device 20 is provided with: a control section 21 including a CPU (Central Processing Unit) 21a, a storage section 21b, such as a ROM (Read Only Memory), a RAM (Random Access Memory), etc., an HDD (Hard Disc Drive) 21c, a communication interface section 21d, such as a NIC (Network Interface Card), a modem, etc., for coupling the client to the communication network, etc.; a display section 22, such as an LCD (Liquid Crystal Display), etc.; an operation section 23, such as a keyboard, a mouse, etc., to conduct various kinds of operations; etc. In the normal operation, the OS (Operating System), the document application program and the device driver (hereinafter, referred to as the printer driver) for controlling the image forming apparatus 40 are read form the ROM or the HDD 21c, and developed into the RAM, so as to be executed by the CPU 21a.

Further, as shown in FIG. 3, the RIP server 30 is constituted by a control section 31, a data receiving section 32, a profile controlling section 33, a color correcting section 34, an image creating section 35, an image transmitting section 36, a display section 37, etc.

The control section 31, serving as a section for controlling various kinds of constituent sections, is provided with a CPU 31a, a storage section 31b, such as a ROM, a RAM, etc., an HDD 31c, a communication interface section 31d, etc., which are coupled to each other through a bus.

The CPU 31a conducts various kinds of controlling operations for each of the sections, various kinds of image processing, etc.

The storage section 31b serves as a section for temporarily storing the print data read by the data receiving section 32. The print data stored in the storage section 31b is processed by the CPU 31a, and successively, transmitted to the image creating section 35 and processed in the color correcting section 34, as needed. Then, the processed print data is stored in the HDD 31c or transferred to the image transmitting section 36, so as to transmit them to the image forming apparatus 40.

The HDD 31c stores various kinds of programs for controlling the sections concerned, information in regard to the processing functions of its own apparatus, etc., which are read by the CPU 31a as needed, in order to execute and process them on the storage section 31b.

The communication interface section 31d establishes connections with the client terminal device 20, the image forming apparatus 40, other external apparatuses, etc., so as to implement the bilateral data communications with them.

The data receiving section 32 receives the print data sent from the client terminal device 20 through the communication interface section 31d. After the reception of the print data is completed, the data receiving section 32 notifies the control section 31 of the above completion, to request for acquiring the updated profile.

The profile controlling section 33 retains both a standard profile and a differential profile, to manage profiles for the color conversion processing to be conducted in the color correcting section 34. The standard profile retains standard characteristics in respect to colors to be reproduced by the objective image forming apparatus 40, while the differential profile retains data representing deviations of colors, actually reproduced by the image forming apparatus 40 concerned, from the standard profile. This differential profile is generated in the image forming apparatus 40 side. The standard profile represents the standard characteristics unique to the model of the image forming apparatus 40, while the differential profile is employed for the purpose of absorbing reproduced color changes due to individual differences between objective bodies (apparatus differences) and/or aging factors. When receiving the instruction for updating the differential profile from the image forming apparatus 40, the control section 31 conducts the updating operation of the differential profile.

The color correcting section 34 conducts the color correction processing of the print data, while applying the profile controlled by the profile controlling section 33.

The image creating section 35 converts the print data, received by the data receiving section 32, to the raster data. Further, when generating the TAG bit to be utilized for determining an object area and processing for every object, the image creating section 35 attaches the information for specifying the image processing condition (herein, the color conversion condition), corresponding to the attribute being different from the image attribute representing a kind of the object, (hereinafter, referred to as an image processing attribute) to the TAG bit concerned, and successively, calls the color correcting section 34 for correcting the colors, so that the color correcting section 34 applies an appropriate color conversion processing to each of the areas included in the raster data on the basis of the TAG bit concerned, and then, combines the raster data after applying the color conversion processing so as to create the output data.

The image transmitting section 36 transmits the output data, created by the image creating section 35, to the image forming apparatus 40.

The display section 37 is constituted by the LCD (Liquid Crystal Display), etc., so as to display various kinds of screens for controlling the operations of the RIP server 30 thereon.

It is appreciated that each of the profile controlling section 33, the color correcting section 34 and the image creating section 35 is configured as either hardware or a controlling program, including computer executable program code for causing a computer to serve as corresponding one of the profile controlling section 33, the color correcting section 34 and the image creating section 35, to be executed by the control section 31.

Further, as shown in FIG. 4, the image forming apparatus 40 is provided with: a control section 41 including a CPU 41a, a storage section 41b, such as a ROM, a RAM, etc., an HDD 41c, a communication interface section 41d, etc.; a display section 42; an operation section 43; a printing section 44; etc. The printing section 44 implements the printing operation based on the output data transmitted from the RIP server 30. For instance, in the printing section 44, an exposure section irradiates a light modulated according to the output data onto a photoreceptor drum that has been uniformly charged with electrostatic charge by a charging device, so as to form a latent image on the photoreceptor drum. Successively, a developing device develops the latent image with toner by adhering the charged toner onto the latent image, and the developed toner image is finally transferred onto a paper medium through a primary transfer roller and a secondary transfer belt. Then, a fixing device fixes the toner image onto the paper medium.

Although the client terminal device 20, the RIP server 30 and the image forming apparatus 40 constitute the printing system 10 in the embodiment shown in FIG. 1, it is also appreciated that the data receiving section 32, the profile controlling section 33, the color correcting section 34 and the image creating section 35, which are to be included in the RIP server 30, are installed in the image forming apparatus 40 as either hardware or software, so that the image forming apparatus 40 itself can implement such the operations as the reception of the print data, the rasterizing operation, the creation of the TAG bit, the color conversion processing, etc., and in such the case, the RIP server 30 can be omitted from the printing system 10.

Next, referring to FIG. 5 and FIG. 6, the processing operations to be conducted in the aforementioned printing system 10 will be detailed in the following. Incidentally, although such the case that a specific color conversion processing is implemented for a specific area by employing the TAG bits, which are utilized for determining an object area or for applying a processing for every object, will be exemplified in the following explanation, the other case in which the other processing, such as a brightness conversion processing, a smoothing processing, an edge enhancement processing, etc., instead of the color conversion processing or in addition to the color conversion processing, is implemented, can be regarded as the same as the exemplified case described in the following.

At first, document data 50 is created in the client terminal device 20 (refer to arrow [1]). The document data 50 includes a single or a plurality of object(s), such as a character, vector data of, an illustration, a graph, etc. (hereinafter, referred to as “graphics”), an image of photograph, etc. (hereinafter, referred to as “image”), etc. A designated area 51 is a partial area of the document data 50 to be designated for implementing the specific color conversion processing, and in the present embodiment, is defined as an area on which the color QR code is printed. In this connection, it is applicable that the designated area 51 is a single or a plurality of object(s), or is a part of a single or a plurality of object(s).

Successively, print data 52 is created in the client terminal device 20 (refer to arrow [2]). The print data 52 is such data that is converted in the format of the Page Description Language, typically represented by the PS (Post Script) or the PCL (Printer Control Language), from the document data 50, which is created by using the application program installed in advance in the client terminal device 20, by using the functions of the printer driver or the other application program. The print data 52 is transferred to the RIP server 30 through the communication network. In this connection, when the document data 50 is described in a file format suitable for the direct printing operation, for instance, the XPS (XML Paper Specification) , the PDF (Portable Document Format), etc., it is applicable that the document data 50 is transferred to the RIP server 30 as it is, without converting them in the format of the Page Description Language.

Herein, in the present embodiment, in order to apply the specific color conversion processing to the designated area 51 of the document data 50, information in which the information for specifying the designated area 51 (for instance, name of the area) and the other information for specifying a profile to be referred for applying the specific color conversion processing are correlated with each other, is attached to the print data 52 (or the document data 50).

Still successively, raster data 54 is created in the RIP server 30 (refer to arrow [3]). The RIP server 30 generates the raster data 54 from the print data 52 (or the document data 50 in case of direct printing operation). Accordingly, the raster data 54 represents the image itself being receivable by the image forming apparatus 40 for printing.

Further, since various kinds of data characteristics reside in various kinds of objects, such as characters, graphics, images, etc., represented by the print data 52, such the characteristics are recognized at the time of the rasterizing operation, to create a TAG bit 53 attached with the attribute information for every pixel (refer to arrow [4]). In the normal practice, in order to utilize the attribute information for determining the area of each of the objects or for conducting the processing operation for every object, the attribute information is divided into two categories of the “character/graphic” and the “image”, or three categories of the “character”, the “graphic” and the “image”. However, in the present embodiment, in order to make it possible to implement a desired color conversion processing for every area by using the TAG bit 53, attribute information being different from that in the normal practice is added to the TAG bit 53, based on color conversion instructing information.

Concretely speaking, as shown in FIG. 6, in order to conduct the processing operation for every object, it is applicable that numeral “0”, numeral “1” and numeral “2” are allotted to the “no image”, the “character/graphic” and the “image”, respectively. Further, in order to make it possible to apply the specific color conversion processing to the specific area, numeral “3” through numeral “7” are newly provided as the user settable items to each of which the user can give an arbitral definition. In the example shown in FIG. 6, numeral “1” is allotted to each of the pixels constituting a character “1a” surrounded by a frame in the document data 50 and numeral “0” is allotted to each of the pixels constituting a background serving as a peripheral space of the character “1a”, while numeral “6” is allotted to each of the pixels included in the designated area 51. In other words, when the TAG bit 53 is employed only for the color conversion processing for every object, it is applicable that the attribute information is set at numerals “0”-“2” as in the conventional practice. However, when the TAG bit 53 is employed not only for the color conversion processing for every object, but also for applying the specific color conversion processing to the designated area 51, the other attribute information (herein, numeral “6”), other than numerals “0”-“2”, is added to the TAG bit 53, since numerals “0”-“2” are merely available for specifying the condition of the color conversion processing only for every object.

Still successively, the color conversion processing is conducted in the RIP server 30 (refer to arrow [5]). This color conversion processing is conducted on the basis of the profile corresponding to the value of the TAG bit 53 by dividing the document data 50 into a partial area excluding the designated area 51 (a normal depicting area 55) and another partial area of the designated area 51 (a designated depicting area 56). Concretely speaking, the color conversion processing of attribute “0” is applied to the image-absence area for which the TAG bit 53 is set at numeral “0”, while the color conversion processing of attribute “1” is applied to the “character/graphic” area for which the TAG bit 53 is set at numeral “1”, so as to create the data of the normal depicting area 55. On the other hand, the color conversion processing of attribute “6” is applied to the designated area 51 (herein, the color QR code), for which the TAG bit 53 is set at numeral “6”, so as to create the data of the designated depicting area 56.

Then, the output image is formed in the RIP server 30 (refer to arrow [6]). This operation for forming the output image is such a processing that combines the normal depicting area 55 and the designated depicting area 56, which are independently created by the respective color conversion processing, with each other. Output data 57, generated as the result of the abovementioned processing, is transmitted to the image forming apparatus 40.

Yet successively, an output product 58 is produced in the image forming apparatus 40 (refer to arrow [7]). The output product 58 is a print product printed by the image forming apparatus 40, based on the output data 57.

Next, referring to FIG. 7 and FIG. 8, the processing operations to be conducted in the aforementioned printing system 10 will be detailed in the following. Initially, referring to the flowchart shown in FIG. 7, the processing operations to be conducted in the client terminal device 20 will be detailed in the following.

The control section 21 of the client terminal device 20 reads out the document application program from the ROM or the HDD 21c, or from the other client terminal device, the server, etc., which are coupled to the client terminal device 20 through the communication network, so as to activate the document application program on its own RAM or that of the other client terminal device, the server, etc. Then, in response to the predetermined operations conducted by the user, the document data 50, serving as the print object, is generated by creating or inserting characters, a graphic, an image, etc. on the document application program (Step S101). Alternatively, it is also applicable that the document data 50 created in advance is acquired from the ROM or the HDD 21c, or from the other client terminal device, the server, etc.

Successively, in response to the predetermined operations conducted by the user, the control section 21 establishes a single or a plurality of designated area(s) 51 (for instance, an area to which a special color processing for a specific usage should be applied, etc.) (Step S102). In this connection, an arbitral method is applicable for establishing the designated area 51. For instance, it is applicable that, when the user designates a specific object, an area occupied by the specific object is established as the designated area 51, or, when the user designates an area by using a mouse, etc., the area designated by the user is established as the designated area 51. Further, it is also applicable that the user himself establishes the designated area 51, or the system is so constituted that the control section 21 of the client terminal device 20 automatically establishes the designated area 51 according to a predetermined rule, such as a rule for establishing an area occupied by a specific object (for instance, an image object) as the designated area 51, another rule for establishing an area, in which a number of colors actually employed exceeds a predetermined number of colors to be employed, as the designated area 51, etc.

Successively, in response to the user's instruction, or according to the predetermined rule, the control section 21 of the client terminal device 20 defines the name of the designated area 51 (Step S103), and then, establishes a profile corresponding to the name defined in the above (Step S104). Further, the control section 21 creates the color conversion instructing information in which the name of the designated area 51 and the profile to be referred to at the time of applying the color conversion processing to the designated area 51 are correlated with each other.

Still successively, the control section 21 of the client terminal device 20 converts the document data 50, attached with the color conversion instructing information, to data described in the Page Description Language, which is created as the print data 52, and then, transmits the print data 52 to the RIP server 30 (Step S105). In this connection, although the system of the present embodiment is so constituted that the document data 50, attached with the color conversion instructing information, is converted to the print data 52, it is also applicable system that the print data 52 is generated at first from the document data 50, and then, the color conversion instructing information is attached to the print data 52, so as to transmit the print data 52 attached with the color conversion instructing information to the RIP server 30.

Next, referring to the flowchart shown in FIG. 8, the processing operations to be conducted in the RIP server 30 will be detailed in the following.

Initially, the data receiving section 32 receives the print data 52 sent from the client terminal device 20 (Step S201).

Successively, the control section 31 requests of sending the information of the color structure from the image forming apparatus 40, so as to determine whether or not the operation for updating the differential profile is necessary (Step S202). When determining that the operation for updating the differential profile is necessary, the control section 31 receives the differential profile from the image forming apparatus 40, and then, the display section 42 updates the differential profile (Step S203).

Still successively, the image creating section 35 parses the print data 52 so as to detect each of the objects constituting the document concerned, each position of the designated area 51 and its attribute (Step S204), and then, rasterizes the print data 52 to create the raster data 54 (Step S205). Further, the image creating section 35 generates the TAG bit 53, based on each of the objects, each position of the designated area 51 and its attribute (Step S206).

Concretely speaking, as shown in FIG. 6, in order to utilize the TAG bit 53 for the processing operation for every object (herein, the color conversion processing), when the object is the “character/graphic”, numeral “1” is attached to each of the pixels constituting the object concerned, and, when the object is the “image”, numeral “2” is attached to each of the pixels constituting the object concerned, while numeral “0” is attached to the pixel at which neither the “character/graphic” nor the “image” exists. Further, in order to utilize the TAG bit 53 for the processing operation for every area (herein, the specific color conversion processing for the designated area 51), the attribute information for designating a specific profile (herein, numeral “6”) is attached to the pixel corresponding to the designated area 51, in addition to numerals “0”-“2”.

In this connection, although the TAG bit 53 constituted by three bits is exemplified in the present embodiment herein, since the TAG bit 53 is utilized for specifying the processing conditions corresponding to the image attribute and the other processing conditions corresponding to the attribute other than the image attribute, it is applicable that the TAG bit 53 is constituted by four bits or more bits, when a large number of the processing conditions should be specified. Further, although the attribute information is allotted to each of the values (“0”-“7”) represented by the decimal notation in the present embodiment herein, it is also applicable that the attribute information is allotted to each of the bits. For instance, it is also applicable that the two bits from the LSB (Least Significant bit) are utilized for the processing operation corresponding to the image attribute, while one bit of the MSB (Most Significant Bit) is utilized for the other processing operation corresponding to the attribute other than the image attribute. Still further, although, in the present embodiment herein, the TAG bit 53 is utilized for the color conversion processing for every image attribute and that for every area, the TAG bit 53 is also utilized for various kinds of processing, such as the brightness conversion processing, the smoothing processing, the edge-enhancing processing, etc., in addition to or in stead of the abovementioned processing.

Still successively, the image creating section 35 determines whether or not the TAG bit 53 represents the normal attribute (namely, whether or not the TAG bit 53 represents the image processing attribute determined corresponding to the image attribute, herein, whether or not the TAG bit 53 is any one of numerals “0”-“2”) (Step S207). When determining that the TAG bit 53 represents the normal attribute (Step S207; Yes), the image creating section 35 calls the color correcting section 34, so that the color correcting section 34 conducts the normal color conversion processing by employing the standard profile controlled by the profile controlling section 33 (Step S208). On the other hand, when determining that the TAG bit 53 does not represent the normal attribute (namely, when the TAG bit 53 represents the specific image processing attribute determined corresponding to the area, herein, when the TAG bit 53 is numeral “6”) (Step S207; No), the image creating section 35 calls the color correcting section 34, so that the color correcting section 34 conducts the special color conversion processing inherent to the designated area 51 by employing the standard profile and the differential profile, both controlled by the profile controlling section 33 (Step S209). In this connection, although the profiles to be referred by the color correcting section 34 are constituted by the standard profile and the differential profile in the present embodiment herein, it is also applicable that the color correcting section 34 refers corresponding one of profiles, each of which is independently established for every attribute.

Yet successively, the image creating section 35 combines the normal depicting area 55, to which the normal color conversion processing is applied on the basis of the image processing attribute determined corresponding to the image attribute, and the designated depicting area 56, to which the special color conversion processing is applied on the basis of the specific image processing attribute determined corresponding to the area, with each other, so as to create the output data 57 (Step S210). Then, the image transmitting section 36 transmits the output data 57 created in the above to the image forming apparatus 40, in order to make the image forming apparatus 40 print the output product 58.

As described in the foregoing, in the printing system 10 embodied in the present invention, the image creating section 35 of the RIP server 30 converts the print data 52 to the raster data 54, and generates the TAG bit 53 in which both the image processing attribute, determined corresponding to the image attribute of the raster data 54, and the specific image processing attribute, determined corresponding to the attribute other than the image attribute, are recorded for every pixel, so as to create the output data 57 by conducting the processing operations based on the image processing attribute recorded in the TAG bit 53 concerned. Therefore, according to the printing system 10 embodied in the present invention, it becomes possible to implement such processing as a special color conversion processing to be applied to a specific area, etc., by extendably utilizing the TAG bit 53, which have been used only for the processing of every object in the conventional system.

Incidentally, although the examples that utilize the TAG bit 53 for conducting the color conversion processing to be applied to the object, the color conversion processing or the brightness conversion processing to be applied to the area, the smoothing processing and the edge-enhancement processing have been described in the foregoing as the embodiment of the present invention, the scope of the present invention is not limited to the above. The present invention is capable of being applied to any other arbitral processing being implementable for the raster data.

The present invention is applicable to a controlling program for generating the TAG bits, a controlling apparatus, an image forming apparatus and a print controlling method.

According to the print controlling program, the print controlling apparatus, the image forming apparatus and the print controlling method, each embodied in the exemplary embodiment described above, it becomes possible to apply both the image processing, corresponding to a kind of the image attribute, and the other image processing, corresponding to a an attribute being different from the image attribute, to the raster data based on the attribute data.

This is because, in the print controlling program, the print controlling apparatus or the image forming apparatus, each of which creates the raster data by rasterizing the print data in which the document data is described in a Page Description Language, when creating a TAG bit in which an image processing attribute determined corresponding to an object represented by the raster data is recorded, another image processing attribute determined corresponding to an attribute being different from the image attribute (for instance, an area attribute) is also recorded in the TAG bit.

For instance, when the image processing attribute, which designates a specific color conversion processing to the specific area, is recorded into the TAG bit, it is possible to implement an appropriate color conversion processing not only in the unit of an object, but also for every individual area. Accordingly, since the color of the specific area can be controlled without conducting any complicated processing, it becomes possible to easily conduct an operation for controlling a color of an area for which a color reproduction processing, being different from the normal color controlling operation, is necessary, such as a company logo, a color QR code, etc.

While the preferred embodiments of the present invention have been described using specific term, such description is for illustrative purpose only, and it is to be understood that changes and variations may be made without departing from the spirit and scope of the appended claims.

What is claimed is:

1. A computer readable medium storing a computer executable program to be executed at a time when print data, which is described in a Page Description Language and includes objects having image attributes being different from each other, is converted to raster data, the program comprising program code for causing a computer to perform the step of:
creating, for each pixel represented by the raster data, attribute data, in which an image processing attribute indicating a kind of image processing to be applied to the pixel is recorded;
wherein the attribute data designates one of image processing attributes that include a plurality of image processing attributes determined according to kinds of the image attributes of the objects and a specific image processing attribute determined corresponding to another image attribute being different from any one of the image attributes of the objects.

2. The computer readable medium of claim 1,
wherein the specific image processing attribute specifies a condition for an image processing to be applied to a partial area represented by a part of the raster data.

3. The computer readable medium of claim 2,
wherein the image processing includes one or more processing operation(s) selected from a color conversion processing, a brightness conversion processing, a smoothing processing and an edge-enhancement processing.

4. A print controlling apparatus that acquires print data, which is described in a Page Description Language and includes objects having image attributes being different from each other, and converts the print data to raster data, comprising:
a print data acquiring section to acquire the print data; and
an image creating section to create, for each pixel represented by the raster data, attribute data, in which an image processing attribute indicating a kind of image processing to be applied to the pixel is recorded, when converting the print data acquired by the print data acquiring section to the raster data, and then, to apply an image processing based on the attribute data to the raster data;
wherein the attribute data designates one of image processing attributes that include a plurality of image processing attributes determined according to kinds of the image attributes of the objects and a specific image processing attribute determined corresponding to another image attribute being different from every one of the image attributes of the objects.

5. The print controlling apparatus of claim 4,
wherein the specific image processing attribute specifies a condition for an image processing to be applied to a partial area represented by a part of the raster data.

6. The print controlling apparatus of claim 4,
wherein the image processing includes one or more processing operation(s) selected from a color conversion processing, a brightness conversion processing, a smoothing processing and an edge-enhancement processing.

7. An image forming apparatus that acquires print data, which are described in a Page Description Language and include objects having image attributes being different from each other, and converts the print data to raster data so as to conduct a printing operation, comprising:
an image creating section to create attribute data, in which an image processing attribute indicating a kind of image processing to be applied to each of pixels represented by the raster data is recorded, for every pixel included in the pixels, when converting the print data to the raster data, and then, to apply an image processing based on the attribute data to the raster data; and
a printing section to conduct the printing operation based on processed raster data acquired by applying the image processing to the raster data;
wherein the attribute data designates one of image processing attributes that include a plurality of image processing attributes determined according to kinds of the image attributes of the objects and a specific image processing attribute determined corresponding to another image attribute being different from every one of the image attributes of the objects.

8. The image forming apparatus of claim 7,
wherein the specific image processing attribute specifies a condition for an image processing to be applied to a partial area represented by a part of the raster data.

9. The print controlling apparatus of claim 7,
wherein the image processing includes one or more processing operation(s) selected from a color conversion processing, a brightness conversion processing, a smoothing processing and an edge-enhancement processing.

10. A print controlling method, comprising:
converting print data, which are described in a Page Description Language and include objects having image attributes being different from each other, to raster data;
creating attribute data, in which an image processing attribute indicating a kind of image processing to be applied to each of pixels represented by the raster data is recorded, for every pixel included in the pixels;
applying an image processing based on the attribute data to the raster data, so as to generate processed raster data; and
conducting a printing operation based on the processed raster data generated in the applying step;
wherein the attribute data designates one of image processing attributes that include a plurality of image processing attributes determined according to kinds of the image attributes of the objects and a specific image processing attribute determined corresponding to another image attribute being different from every one of the image attributes of the objects.

11. The print controlling method of claim 10,
wherein the specific image processing attribute specifies a condition for an image processing to be applied to a partial area represented by a part of the raster data.

12. The print controlling method of claim 10,
wherein the image processing includes one or more processing operation(s) selected from a color conversion processing, a brightness conversion processing, a smoothing processing and an edge-enhancement processing.
